(19) United States
(12) Patent Application Publication
(10) Pub. No.: US 2017/0113529 A1
(43) Pub. Date: Apr. 27, 2017

(54) Electronic Car Umbrella

(71) Applicant: Othman Mohammed Alshamrani, Seattle, WA (US)

(72) Inventor: Othman Mohammed Alshamrani, Seattle, WA (US)

(21) Appl. No.: 14/924,076

(22) Filed: Oct. 27, 2015

(51) Int. Cl. B60J 11/04; H02J 7/35; E04H 15/54; E04H 15/06; E04H 15/44

(52) U.S. Cl. CPC B60J 11/04; E04H 15/06; E04H 15/44; E04H 15/54; H02J 7/355

(57) ABSTRACT

The present invention provides a protective cover assembly for a vehicle to keep the vehicle cool and protect it from damage from the sun. The protective cover assembly includes a cover, a plurality of hydraulic columns, and a plurality of magnetic ropes stored removably inside a box. The cover contracts and expands with help of the plurality of hydraulic columns and the plurality of magnetic ropes to cover the entire body of the vehicle. The box of the protective cover assembly can be removably connected to the top of a vehicle. The protective cover assembly can be supplied with power by battery and solar cells. The protective cover assembly can be easily either operated manually, or automatically with the help of remote control and mobile devices.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of Invention

The present invention generally relates to a protective cover assembly for a vehicle. More particularly, the present invention relates to “a protective cover assembly to keep a car cool and protect it from damage from the sun”.

(2) Background of Invention

A major issue with vehicles being parked in sun is that the heat and other radiations from the sun causes damage to the vehicle. For example, it causes damage to the vehicle paint.

Furthermore, the heat radiation from the sun makes the interior of the vehicle hot, thereby making it very unpleasant to enter the vehicle and travel. This is because the metallic body of the vehicle is a good conductor of heat, and thus absorbs heat to subsequently transfer this heat to the atmosphere inside of the vehicle. Another issue with the heating of the vehicle is that some types of articles, such as fruits, foods, etc., suffer damage from the heat built up inside the vehicle. Hence, it is highly needed to provide a method and system for protecting the vehicle from the heat and other radiations from the sun. Some attempts have been made at providing solution for this issue. For example, U.S. Pat. No. 2,768,672 A, issued to Malvido Doormann Luz on Oct. 30, 1956, discloses a method of insulating the vehicle bodies with a thin layer of asbestos, which conforms in shape to the section of the vehicle body to which it is applied. The thin layer of asbestos provides insulation to the vehicle body and maintains a uniform temperature. Similarly, U.S. Pat. No. 7,267,386 B2 issued to Rolf Hesch on Sep. 11, 2007, discloses an outer sheet that has a layer of infrared radiation reflective material and an inner part made of thermal insulation material. Both the outer sheet and the inner part are disposed over the body part of a vehicle for heat insulation and dissipation. Similarly, U.S. Pat. No. 5,328,230 A, issued to Curchod Donald B on Jul. 12, 1994, discloses a storable cover for covering the cabin portion of a variety of vehicles to provide sun protection for the interior of the vehicle. However, these methods do not provide a complete and effective protection to the vehicle against the damage from heat and radiation from the sun. Hence, it is desired that an apparatus is provided that can provide effective protection to the vehicle against the damage from heat and other radiation of the sun. It is also desirable that the apparatus and method of its use is easy. Furthermore, it is desired that the apparatus can be operated automatically, as well as manually.

It is an aspect of the invention to overcome or alleviate a problem of the prior art.

This permits the use of the present invention, which enhances the prior art of the method and apparatus for keep a car cool and protecting it from damage from the sun.

### BRIEF SUMMARY OF THE INVENTION

In view of the foregoing, one aspect of the various disclosed embodiments of the present invention is to provide a protective cover assembly for a vehicle.

Preferably, the protective cover assembly for a vehicle addresses, or at least ameliorates, one or more of the problems described above. To this end, the present invention, related to a protective cover assembly for a vehicle with some unique aspects, is disclosed.

Accordingly, it is a primary objective of the present invention to provide a protective cover assembly for a vehicle to keep the vehicle cool and protect it from damage from the sun. The protective cover assembly includes a cover, a plurality of hydraulic columns, and a plurality of magnetic ropes stored removably inside of a box.

It is another objective of the present invention that the cover of the protective cover assembly can contract and expand to cover the entire body of the vehicle.

It is yet another objective of the present invention that the box of the protective cover assembly can be removably mounted on the top of a vehicle.

It is yet another objective of the present invention that the box of the protective cover assembly can be mounted on the top of a vehicle by a locking mechanism.

It is yet another objective of the present invention that the protective cover assembly can be supplied with power by solar cells.

It is still another objective of the present invention that the protective cover assembly can be easily operated either manually and automatically.

Other objectives of the present invention will become apparent, from time to time, throughout the specification, as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 shows a perspective view of the protective cover assembly;

FIG. 2 shows a perspective view of the cover of the protective cover assembly;

FIG. 3 shows a perspective view of a hydraulic column of the protective cover assembly;

FIG. 4 shows a perspective view of the flow of the start operation of the protective cover assembly;

FIG. 5 shows a perspective view of the protective cover assembly during its closed state;

FIG. 6 shows a perspective view of the protective cover assembly during its use;

FIG. 7 shows a perspective view of the cover, hydraulic column, and magnetic role;

FIG. 8 shows a perspective view of a hydraulic column of the protective cover assembly in its fully expanded state;

FIG. 9 shows a perspective view of the protective cover assembly fully covering the body of vehicle.

### DETAILED DESCRIPTION OF THE INVENTION

The following detailed description of the present invention enables teaching of the invention and its best, currently known embodiment. Those skilled in the art can understand that many changes can be made to the embodiments described, while still obtaining the beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made, may be desired in certain circumstances, and are part of the present invention. Thus, the following description is provided as illustrative of the principle of the present invention.

Embodiments of the present invention provide a protective cover assembly for a vehicle to keep the vehicle cool and protect it from damage from the sun, such as damage to vehicle paint. Accordingly, the specific embodiments discussed herein are merely illustrative of specific manners in which to make and use this invention, and are not intended to represent an exhaustive list of all possible structure and processes of the present invention.

Embodiments of the apparatus and method of using it are shown in the figures, and discussed below. While the structure and processes have been described with a certain degree of particularity, it is to be noted that many modifications may be made in the details of the structure and processes without departing from the spirit and scope of this disclosure. It is understood that the structure and processes are not limited to the embodiments set forth herein for purposes of exemplification.

Aspects of the present inventive subject matter are described with reference to the figures provided herein.

The present invention provides a protective cover assembly for a vehicle. The vehicle is preferably a car of different types, including, but not limited to, sedans, hatchbacks, and vans.

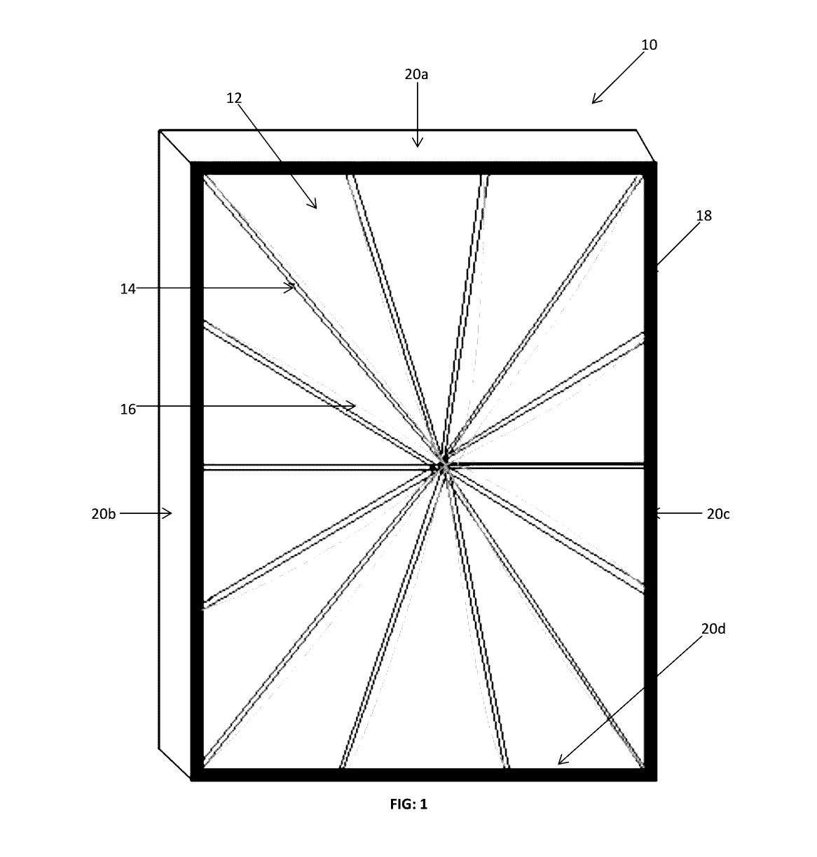

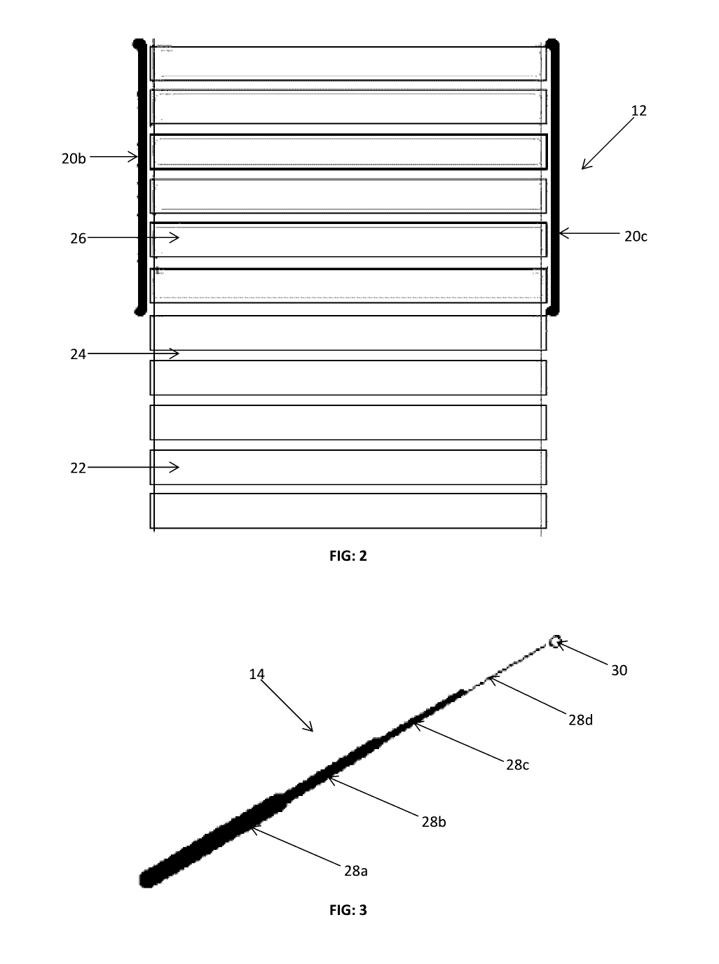

FIG. 1 illustrates a preferred embodiment of the present invention in which the protective cover assembly 10 includes a cover 12, a plurality of hydraulic columns 14, a plurality of magnetic ropes 16, and a box 18. The box stores the cover, the plurality of hydraulic columns, and the plurality of magnetic ropes. The box is positioned in the middle of the top of the vehicle. The box is removably connected to the retaining structures present on the top of the vehicle by suitable means known in the prior art. The box 18 can be removed from the top of the vehicle when it is not needed, and then reconnected when needed. In a preferred embodiment of the present invention, the box is installed at the top of the vehicle by means of a locking mechanism to prevent the box from being stolen. In this manner, the box can be left connected to the top of the vehicle. The box can be removed from the top of the vehicle by unlocking it from the retaining structures. The box has four sidewalls 20a, 20b, 20c & 20d, a bottom, and a top. The four sidewalls of the box can open to allow the cover, hydraulic columns, and magnetic ropes to move outside. As shown in FIG. 2, the cover 12 consists of four layers. The first layer is the lowermost layer, and is made of small rectangular pieces of wood 22. The second layer is present above the lowermost layer and consists of a strong flexible material 24 for isolating the water and sand. The strong flexible material is preferably a strong cloth or fabric. The third layer is made of a hollow strong plastic material that has liquid nitrogen or nitrogen gas sealed inside it. The third layer creates a cool environment and highly reduces the development of heat. The plastic material is preferably transparent. The second layer is connected to the first layer and the third layer by a suitable means. The fourth layer, which is also the uppermost layer of the cover, is made of mirror plates 26. These mirror plates are attached to the plastic material of the third layer with help of suitable connecting means. The mirror plates are enameled by reflective material by being painted in their back with tin and mercury. The mirror plates further have a coating black paint over the tin and mercury paint. The mirror plates reflect heat and other radiations from the sun. The cover further includes ropes made of copper. The cover also includes aluminum and iron.

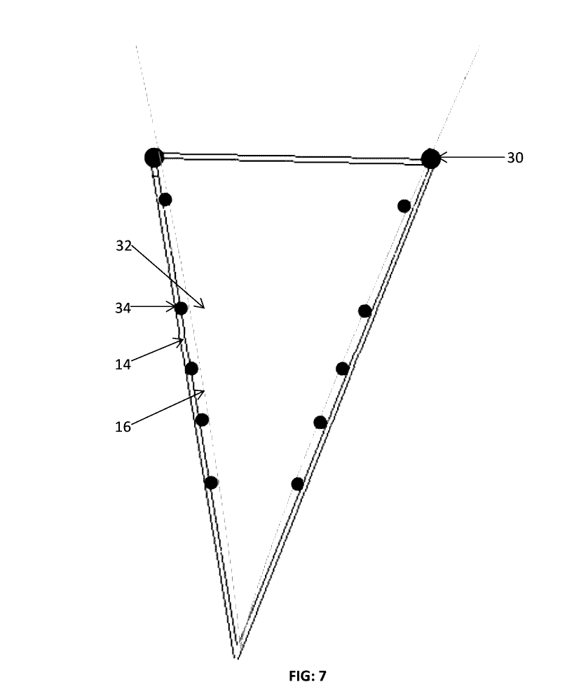

The cover can fold up to contract and unfold to expand. The magnetic ropes, hydraulic columns, and the cover work together during the operation of the protective cover assembly. The hydraulic columns and magnetic rope helps in contraction and expansion of the cover. The hydraulic columns are present inside specific paths in the cover, and work to contract and expand the cover based on hydraulic mechanism. As shown in FIG. 3, the hydraulic column 14 is made of plurality of tube members 28a, 28b, 28c & 28d telescopically connected to each other such that a tube member comes in or out of its corresponding outer tube member to allow the hydraulic column to contract or expand respectively. For example, the tube member 28b moves in and out of the tube member 28a. The outermost tube member 28d of each of the hydraulic column has roller 30 at its outer end, as shown in FIGS. 3 & 5. Again referring to FIG. 1, the magnetic rope 16 is present inside of the hydraulic column 14 with the outer end of the magnetic rope connected to the outer edge of the cover and the inner end of the magnetic rope connected to a reel. The reel is present in the middle of the box. The reel winds and stores the magnetic rope. The magnetic rope winds up on the reel to shorten the magnetic rope and is unwound to lengthen the magnetic rope. The reel is magnetic to allow the magnetic rope to wind up and unwind slowly. Both the magnetic rope and the reel are permanent magnets. The magnetic rope is made of a strong and flexible material. The cover 12 has a specific path inside of it for the plurality of hydraulic columns 14 through which the hydraulic column expands and contracts. As shown in FIG. 7, the cover has small joints 32 that connect the cover to the small joints 34 present on the hydraulic column. The connection between the small joints of the cover and the small joints of the hydraulic column helps the cover to expand and contract easily and proportionally as the hydraulic column is expanded and contracted.

The protective cover assembly is operated with the help of a control unit having a processor and a power source. The power source is a battery. The processor and power source can be preferably housed in the box. The battery is a rechargeable battery and can be charged by connecting to an external power source or solar cells. The solar cells are positioned on the top of the box. The solar cells can also supply power directly for the operation of the protective cover assembly. The battery can be replaced if damaged. A switch is provided to turn on or off the protective cover assembly. The switch is connected to the processor. The switch is preferably provided in a remote control. In another aspect of the present invention, the switch is provided through an app installed in a mobile device. The mobile device may include, but is not limited to, mobile phones, tablets, etc.

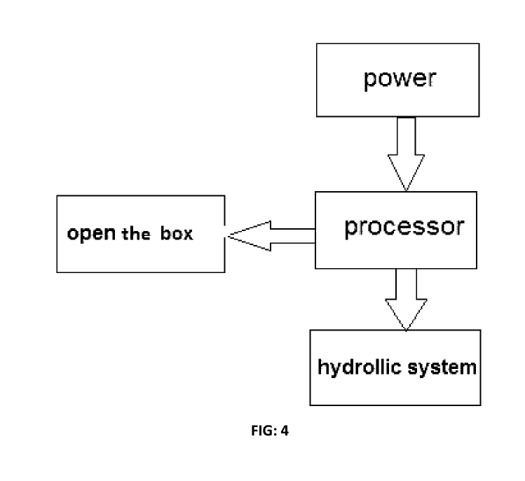

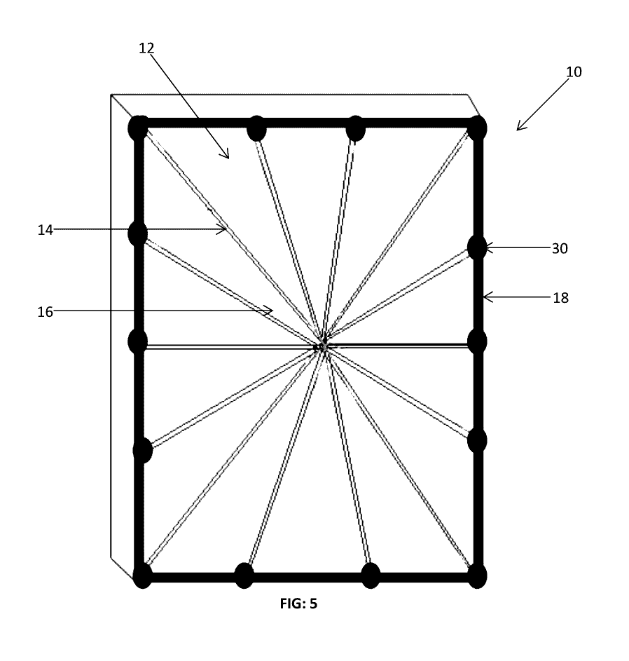

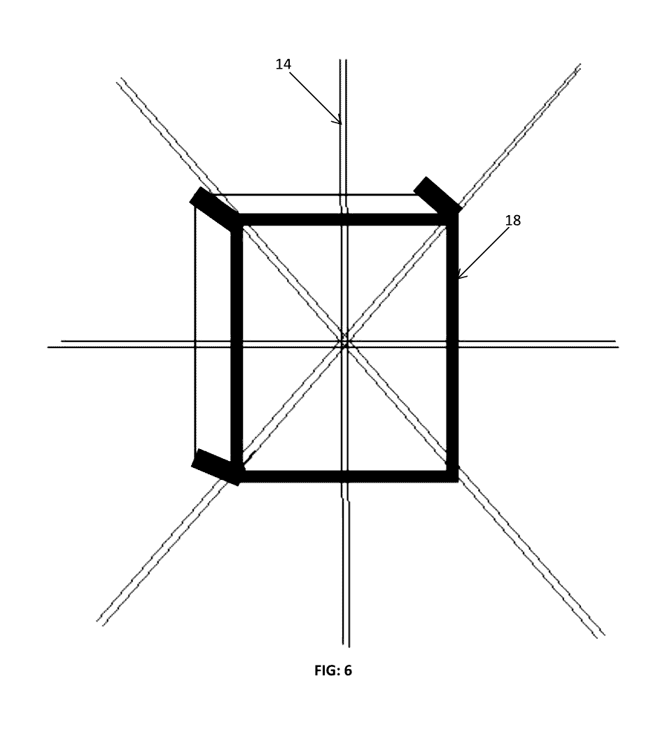

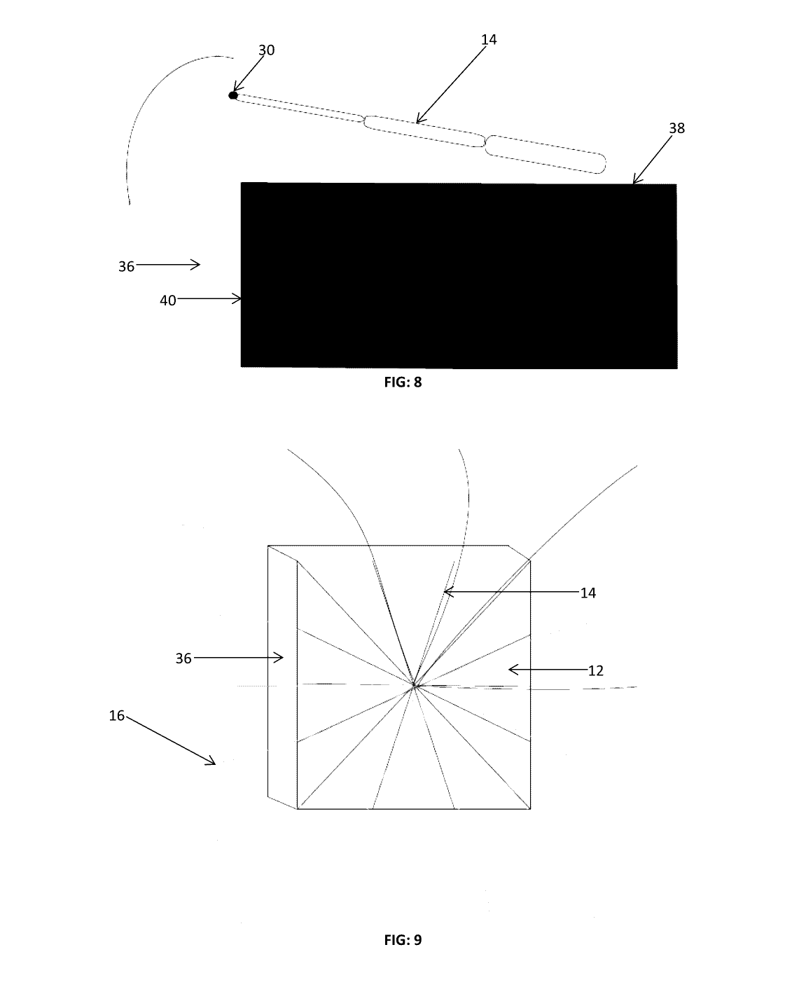

Referring to FIG. 4-9 showing the operation of the protective cover assembly 10, when the switch is turned on, the power source starts supplying power to the processor and the sides 20a, 20b, 20c & 20d of the box 18 are opened. Each of the hydraulic columns rises up and expands, as shown in FIGS. 6 & 8 by movement of the tube member of the hydraulic column outside of their telescopically connected outer tube member. Along with the expanding hydraulic columns 14, the magnetic rope unwinds. The expanding hydraulic columns and the lengthening magnetic rope start unfolding the cover with the help of the connection between the small joints on the hydraulic column and the small joints on the cover, as shown in FIG. 7. The unfolding cover is moved towards the edge of the top 38 of the vehicle 36, thereby covering the top of the vehicle with the cover. The hydraulic columns top expanding once the cover reaches the edge of the top of the vehicle, while the magnetic rope 16 keeps unwinding to allow the unfolding cover to move beyond the edge of the top of the vehicle. When the cover 12 progresses beyond the edge of the top 38 of the vehicle 36, it starts moving vertically downwards along the sides 40 of the vehicle to cover the sides of the vehicle, as shown in FIG. 8. The rollers 30 present at the outer end of the outermost tube member of the hydraulic column 14 assist in the smooth, vertical, downwards movement of the cover material. The magnetic rope 16 controls the vertical downwards movement of the cover, so as to prevent the cover material from free falling. The magnetic rope allows the cover to move vertical downwards gradually and slowly. This helps in protecting any damage to the cover movement, which may happen from the impact from the free fall of the cover. Once the cover is completely expanded, the outer edge of the cover is present at the bottom of the sides of the vehicle thereby protecting the entire body of the vehicle, as shown in FIG. 9.

When the vehicle is not to be protected, the operation of the protective cover assembly can be turned off using the switch. This causes the reel to start winding up the magnetic rope. This results in the gradual vertical upwards movement of the cover material with the shortening magnetic rope. When the bottom of the cover material reaches the edge of the top of the vehicle, each of the plurality of hydraulic columns begin contracting with the shortening magnetic rope to eventually bring the shortened hydraulic columns, shortened magnetic ropes, and the contracted cover material inside of the side walls of the box. The sidewalls of the box then close to store the shortened hydraulic columns, shortened magnetic ropes, and the contracted cover material inside of the box.

In a preferred embodiment of the present invention, the processor can be programmed to automatically shut down the operation of the protective cover assembly and store the collapsed cover, contracted hydraulic columns, and contracted magnetic rope inside the box when the sun radiation is hidden, the weather is cloudy, or at night. The automatic mode of operation of the protective cover assembly can be manually activated and deactivated.

It is to be understood that the above description is intended to be illustrative, and not restrictive. For example, the above discussed embodiments may be used in combination with each other. Many other embodiments will be apparent to those of skill in the art upon reviewing the above description.

Whereas the construction and methods have been described in relation to the figures of the drawings, it should be understood that other and further modifications, apart from those shown or suggested herein, may be made within the spirit and scope of this invention.

I claim:

1. A protective cover assembly for a vehicle, comprising:
a box, wherein the box is removablly mounted on top of the vehicle using a locking mechanism;
a cover, wherein the cover includes a plurality of layers;
a plurality of hydraulic columns, wherein the plurality of hydraulic columns includes a plurality of tube members;
a plurality of magnetic ropes, wherein the plurality of magnetic ropes are positioned inside the plurality of hydraulic columns; and,
a reel.

2. The protective cover assembly for a vehicle according to claim 1, wherein said box comprises at least one side wall, a top and a bottom.

3. The protective cover assembly for a vehicle according to claim 1, wherein said cover, said plurality of hydraulic columns, said plurality of magnetic ropes and said reel are housed inside said box.

4. The protective cover assembly for a vehicle according to claim 1, wherein said plurality of layers further includes a first layer, a second layer, a third layer and a fourth layer.

5. The protective cover assembly for a vehicle according to claim 4, wherein said plurality of layers are interconnected with each other.

6. The protective cover assembly for a vehicle according to claim 4, wherein said first layer is lowermost layer made of a plurality of small rectangular pieces of wood.

7. The protective cover assembly for a vehicle according to claim 4, wherein said second layer is above said first layer.

8. The protective cover assembly for a vehicle according to claim 7, wherein said second layer is made of a strong flexible material for isolating water, sand or the like.

9. The protective cover assembly for a vehicle according to claim 4, wherein the third layer is above said second layer and reduces the development of heat.

10. The protective cover assembly for a vehicle according to claim 4, wherein the third layer is made of a hollow plastic material.

11. The protective cover assembly for a vehicle according to claim 10, wherein a liquid nitrogen or nitrogen gas is sealed inside the hollow plastic material.

12. The protective cover assembly for a vehicle according to claim 4, wherein the fourth layer is the uppermost layer attached to the hollow plastic material of the third layer.

13. The protective cover assembly for a vehicle according to claim 12, wherein said fourth layer is made of a plurality of mirror plates enameled by a reflective material.

14. The protective cover assembly for a vehicle according to claim 13, wherein the reflective material is tin, mercury or the like.

15. The protective cover assembly for a vehicle according to claim 1, wherein the plurality of tube members are telescopically connected to each other.

16. The protective cover assembly for a vehicle according to claim 15, wherein said plurality of tube members move in or out of each other to allow the plurality of hydraulic columns to contract or expand.

17. The protective cover assembly for a vehicle according to claim 15, wherein a roller is connected to an outer end of each of outermost tube members of said plurality of hydraulic columns.

18. The protective cover assembly for a vehicle according to claim 1, wherein said plurality of magnetic ropes are connected to an outer edge of the cover.

19. The protective cover assembly for a vehicle according to claim 1, wherein an inner end of said plurality of magnetic ropes are connected to said reel.

20. The protective cover assembly for a vehicle according to claim 19, wherein said reel is configured to wind and store said plurality of magnetic ropes.

21. The protective cover assembly for a vehicle according to claim 1, wherein said plurality of magnetic ropes and said reel are permanent magnets.

22. A system for controlling operation of the protective cover assembly, comprising:
a control unit, wherein the control unit includes a processor, and a power source;
a plurality of solar cells, wherein the plurality of solar cells are mounted on top of the box; and
a device.

23. The system for controlling operation of the protective cover assembly according to claim 22, wherein said control unit is housed inside the box.

24. The system for controlling operation of the protective cover assembly according to claim 22, wherein said power source powers the processor.

25. The system for controlling operation of the protective cover assembly according to claim 22, wherein said power source is a rechargeable battery.

26. The system for controlling operation of the protective cover assembly according to claim 25, wherein said rechargeable battery is charged using the plurality of solar cells.

27. The system for controlling operation of the protective cover assembly according to claim 22, wherein said device is a smart-phone or the like.

28. The system for controlling operation of the protective cover assembly according to claim 22, wherein said control unit is operated by a remote control means.

29. The system for controlling operation of the protective cover assembly according to claim 28, wherein said remote control means is a computer implemented application.

30. The system for controlling operation of the protective cover assembly according to claim 28, wherein the computer implemented application is enabled on a processor of the device.
